(19) United States
(12) Patent Application Publication
(10) Pub. No.: US 2001/0012153 A1
(43) Pub. Date: Aug. 9, 2001

(54) LAMINATED ARRANGEMENT AND METHOD FOR THE RETROFLECTION OF LIGHT

(76) Inventor: PETER U. HALTER, FRAUENFELD (CH)

Correspondence Address: RANKIN, HILL, PORTER & CLARK, LLP, 700 HUNTINGTON BUILDING, 925 EUCLID AVENUE, CLEVELAND, OH, 44115-1405, US

(21) Appl. No.: 09/307,081

(22) Filed: May 7, 1999

(30) Foreign Application Priority Data
Jul. 24, 1998 (CH) 01 567/98

(51) Int. Cl. G02B 5/30; G02B 27/28

(52) U.S. Cl. 359/487

(57) ABSTRACT

A laminated structure for retroreflection of light has a first, phase-modifying layer (1) and a second, retroreflecting layer (2). Retroreflection can be achieved with glass balls (21.1, 21.2, etc.) having back surfaces (23) metallized with a metal coating (24). The first layer (1) and the second layer (2) are interconnected by a first adhesive coating (3). On a first traversal of the first layer (1), the polarization of an incident light beam (8) is modified and the light beam is then retroreflected. When passing through the first layer a second time, the polarization state is changed again. The structure has high reflectivity even when tilted, a controllable, stable polarization change and locally homogeneous reflectivity.

### FIELD OF THE INVENTION

This invention relates to a laminated arrangement and to a method for the retroreflection of light.

### BACKGROUND OF THE INVENTION

For the retroreflection of light, such as in reflection light barriers, use is often made of retroreflection foils or films, because they are flexible and practical to use. In such optical retroreflectors, retroreflection in the incidence direction with a high reflectivity and a small cone angle within which the light is retroreflected are required.

Conventionally, polarization filters are used in reflection light barriers in order to also detect strongly reflecting objects. Typically, a light source emits linearly polarized light, its polarization direction is rotated by the retroreflector and a detector is provided with an analyzer which only permits the passage of light with a polarization direction rotated by 90°. Alternatively, the light can be depolarized by the retroreflector. As a result of these measures, strongly reflecting objects are detected, because they do not normally modify the light polarization. If retroreflectors are to be used in conjunction with such polarization filter light barriers, they must consequently modify the light polarization, e.g. rotate the polarization or depolarize the light.

Polarization rotation can be achieved in two different ways:

A. Rotation of the polarization direction by the reflection characteristics. For this purpose, a reflection boundary surface is required, which does not metallically reflect, because in metallic reflection the polarization is exactly maintained. Rotation is normally achieved with a boundary surface of two dielectrics such as, e.g., glass-air or acrylic plastic (Plexiglas)—air. When there are sufficiently large angles of incidence in the optically more dense dielectric, total reflections occur and the light polarization is modified.

B. Rotation of the polarization direction by birefringence, which is, e.g., obtained with the aid of stresses in a trans-illuminated material, such as, e.g., acrylic plastic (stress birefringence).

A distinction is made between three types of retroeflection films:

(1) Retroreflection films based on a triple structure (in part with triples cut to a different extent) and whose back is metallized. In such films, a pressure-sensitive adhesive can directly apply the film to the metallized surface.

(2) Retroreflection films based on a triple structure (in part with triples cut to different extents) and whose back bounds air, so that a Fresnel reflection can take place on the boundary layer between the back and the air. To be able to use such films under different ambient conditions, the back of the film must be hermetically sealed so that there is no dirtying or condensation of water there. This is normally accomplished with a protective film behind the actual retroreflection film, the protective film being welded or bonded to the retroreflection film. Typical of such films are their welded areas, which normally have a honeycomb pattern or some similar pattern.

(3) Retroreflection films based on glass balls, which are metal backed. In this type a distinction can be made between three subtypes:

(a) Bare glass balls on the surface.

(b) Bare glass balls, protected against dirtying and/or wetting by a protective film above (in front of) the balls. Such protection is recommended, because refraction is greatly modified in the glass balls if they are dirty and/or wetted with a liquid or an adhesive, the strong retroreflection characteristic then being lost. The protective film must be sealed toward the retroreflection film, which here again takes place with a weld or a bond (cf. type (2)). Thus, this subtype also has welded joints in a honeycomb pattern.

(c) Glass balls embedded in an epoxy resin which protects the glass balls against dirtying and/or wetting.

A first, important criterion for retroreflection films is their permitted tilt angle with respect to an incident light beam. Retroreflection films of types (1) and (2) suffer from the disadvantage that their reflectivity decreases greatly when they are tilted relative to the incident beam. In general, the reflectivity of these retroreflection films decreases considerably even at a tilt angle of approximately 10° and with an angle of 30° their reflectivity is usually unacceptably low. This places a great restriction on their practical use. However, retroreflection films of type (3) permit use down to tilt angles of approximately 40°.

A second criterion for the retroreflection films is their usability in polarization filter reflection light barriers. Retroreflection films of type (1) are not very suitable for uses in polarization filter reflection light barriers, because in their case there is in theory no or virtually no controlled (stress birefringence-caused) polarization change. Retroreflection films of type (3) are completely unsuitable, because neither in theory nor in practice does a polarization change occur. Thus, only retroreflection films of type (2) are suitable for use in polarization filter reflection light barriers.

However, there is a third criterion for retroreflection films, which makes the use of retroreflection films of type (2) problematical in laser reflection light barriers, namely, the homogeneity of the film. Laser light barriers produce a locally sharply defined light beam with a small diameter. Frequently, the laser beam is focused, so that the light spot at certain distances from the laser light source is definitely smaller than 1 mm. If retroreflection films of type (2) are used in such laser light barriers, the welding areas are prejudicial, because they represent inactive, nonreflecting areas. If the laser beam passes along the retroreflection film, it switches the sensor on and off as a result of these welding areas.

Thus, hitherto there have been no retroreflection films which would fulfil in a virtually ideal manner the desired criteria:

high reflectivity on tilting,

controllable, stable polarization change, and

locally homogeneous reflectivity.

### SUMMARY OF THE INVENTION

An object of the invention is to provide an arrangement and a method for the retroreflection of light, which do not suffer from the aforementioned disadvantages.

A laminated structure for the retroreflection of light according to the invention comprises a first layer and a second layer in which the polarization state of the light can be modified by means of the first layer and at least part of the light is retroreflectable by means of the second layer. The first and second layers need not be intrinsically homogeneous, but each of those layers can itself be formed from several layers. Apart from the first and second layers, the structure according to the invention can also incorporate further layers.

The first and second layers are preferably compactly and non-homogeneously placed on one another, e.g., by means of an adhesive coating between the first and second layers. Thus, a unified laminate is formed. A perfect lamination with no air bubbles is vital. The adhesive coating can be a separately applied, special adhesive or an adhesive coating of a pressure adhering, polarization-modifying film. The inventive laminated structure is preferably flexible, so that it forms a retroreflection film.

In the preferred embodiment, the first layer forms the top or front of the structure. It is therefore exposed and should be very resistant to the environment, e.g., insensitive to water and a maximum number of cleaning agents and detergents. It must also be very transparent and planar, so as to absorb no light or deflect it in undefined directions. Suitable materials are, e.g., plastics films.

The first layer is, e.g., constructed as a phase retardation element, particularly as a λ/4 plastics retardation film. It is consequently preferably birefringent and can be stretched in such a way that a suitable birefringence occurs. The birefringence must reach a good value, so that the polarization direction, on passing twice through the first layer, is rotated by 90°. For this purpose, phase retardation of a quarter wavelength of the light (λ/4) or an odd-numbered multiple thereof is introduced. In the embodiment with a λ/4 film the structure only functions adequately if the polarization direction of the incident light is oriented by approximately ±45° with respect to the birefringence axes. Thus, the structure is preferably cut or marked in a clearly defined angle with respect to the birefringence axes. This orientation must be maintained during use (rotation angle with the axis parallel to the incident light beam).

The first layer can also be in the form of a liquid crystal layer, which modifies the polarization state of incident light. This can, e.g., be achieved with a liquid crystal having oblique molecules. For this purpose there is no need to apply a voltage to the liquid crystal. An advantage of this embodiment is that the liquid crystal film need not be oriented in all cases in the rotation angle (rotation axis parallel to the incident light beam). This is unlike the embodiment with a phase retardation element, in which the aforementioned orientation is necessary.

In another embodiment of the inventive structure, the first layer can be constructed as a circular polarizer. Circular polarizers conventionally comprise a λ/4 retardation element and a connecting, correctly oriented linear polarizer and are obtainable as plates or films. In the inventive structure, the λ/4 retardation element faces the incident light and the linear polarizer is positioned between the λ/4 retardation element and the second layer. As a function of the rotation orientation (rotation axis parallel to the incident light axis) of the circular polarizer with respect to the incident, linearly polarized light, various cases are conceivable:

A retardation axis and the polarization direction of the incident light form an angle of 45°. The incident light is first converted by the retardation element into circularly polarized light and by the linear polarizer back into linearly polarized light. It is retroreflected on the second layer and no polarization change occurs. It is then transmitted through the linear polarizer and is converted again into circularly polarized light on the second traversal of the retardation element.

A retardation axis and the polarization direction of the incident light coincide. During the first traversal of the retardation element the light polarization is not changed, but part of the light is absorbed in the linear polarizer. Linearly polarized light, whose polarization direction is rotated by 45° compared with that of the incident light, strikes the second layer. The light is retroreflected, without polarization change, by the second layer. On the second traversal of the linear polarizer there is once again no change to the polarization. On the second traversal of the retardation element the light is finally converted into circularly polarized light.

If the mutual orientation of the retardation axis and polarization direction is between the above-described special cases, the incident light is first converted into elliptically polarized light and then linearly polarized. It is finally re-transmitted as circularly polarized light.

This embodiment has the advantage that the circular polarizer does not have to be oriented in the rotation angle (rotation axis parallel to the incident light beam). However, this advantage is acquired at the cost of the disadvantage that less than half the light is retroreflected as compared with a comparable embodiment in which the first layer merely comprises a phase retardation element.

In another embodiment the first layer can be constructed as a depolarizer.

The second layer can, e.g., be such that it reflects, e.g., metallically reflects the incident light without phase retardation. It can contain spherical or triple retroreflecting structures, which on one side can be at least partly metallized. For such structures are, e.g., suitable retroreflection films of type (3), because they have a high reflectivity over a large tilt angle range of 0° to approximately 40°. This characteristic is scarcely impaired by an appropriately chosen, first layer and is an ideal prerequisite for all retroreflector uses. Retroreflection films of type (3) have a large light retroreflection angle. Such a divergence can be a disadvantage if the light has to travel over long distances (e.g. >1 m). In the case of long light distances, even in the case of laser reflection light barriers, usually retroreflection films of type (2) can be used without the welded joints being prejudicial. In the near zone, the relatively large retroreflection angle is not a disadvantage, whereas, due to the retroreflection angle, the blind zone of a reflection light barrier can become smaller.

As the first layer, retroreflection films of subtype (3)(c) are particularly suitable, i.e., glass balls embedded in a support layer or base. For the support layer, use is preferably made of epoxy resin because it has virtually no birefringence and consequently no influence on the light polarization. The two other retroreflection film subtypes are less suitable for the following reasons. After bonding to a first, polarization-modifying layer, the glass balls of subtype (3)(a) would be inactive as retroreflectors. Subtype (3)(b) suffers from the disadvantage that the honeycomb pattern has inactive points with respect to the retroreflection.

Another embodiment of the inventive, laminated structure uses retroreflection films of subtype (3)(a) as the second layer. In this embodiment, the first layer (preferably in the form of a phase retardation film) is not bonded to, but instead placed on, the second layer. Normally, protection is required around this structure. It can, e.g., be bonded behind a glass or plexiglass cover. The back protection can, e.g., be achieved with a two-sided adhesive tape.

Another embodiment is based on a micro-prism triple reflector with a metallized back according to type (1), to whose front is applied a first layer, e.g., a phase retardation film. Without the first layer, the triple reflector must have no birefringence. This can be achieved by very thin reflector material, by tempering and/or by low-stress manufacture of the reflector.

The method according to the invention for the retroreflection of light by means of a laminated structure, which has a first layer and a second layer, contains the following stages: a) the light traverses the first layer a first time, b) at least part of the light is retroreflected on the second layer and c) the retroreflected part of the light traverses the first layer a second time; the polarization state of the light being modified during the first and/or second traversal of the first layer.

### BRIEF DESCRIPTION OF THE DRAWINGS

The invention is described in greater detail hereinafter referring to the attached drawings, wherein:

FIGS. 1, 2 and 3 are side views of three embodiments of the structure according to the invention;

FIG. 4 is a schematic representation of the inventive method as applied to the embodiment of FIG. 1;

FIGS. 5, 6 and 7 are plan views of retroreflector embodiments with triple structures.

### DESCRIPTION OF PREFERRED EMBODIMENTS

FIG. 1 is a side view of a preferred embodiment of a laminated structure according to the invention. The structure is constructed as a flexible retroreflector film. It comprises a first layer 1, which is preferably in the form of a plastic phase retardation film, e.g., a λ/4 film. As an alternative, the first layer can be constructed as a circular polarizer, as a depolarizer or as a liquid crystal layer. The structure also comprises a second layer 2, which contains retroreflective structures, preferably in the form of glass balls 21.1, 21.2, etc., typically with diameters of approximately 0.1 mm. The back surfaces 23 of the glass balls 21.1, 21.2, etc. are metallized with a metallic reflection coating 24. They are embedded in a carrier layer 25, preferably of epoxy resin. First layer 1 and second layer 2 are joined together by a first adhesive coating 3. An incident light beam 8, which is to be retroreflected, passes through a front surface 10 of the structure, strikes the reflective portions thereof and leaves the structure through front surface 10 as a retroreflected light beam 9. On a back surface 20, the structure is provided with a second adhesive coating 4, which serves to attach the structure to a support, not shown. Adhesive coating 4 is protected by a protective film 5, which is removed prior to attaching the structure to a support.

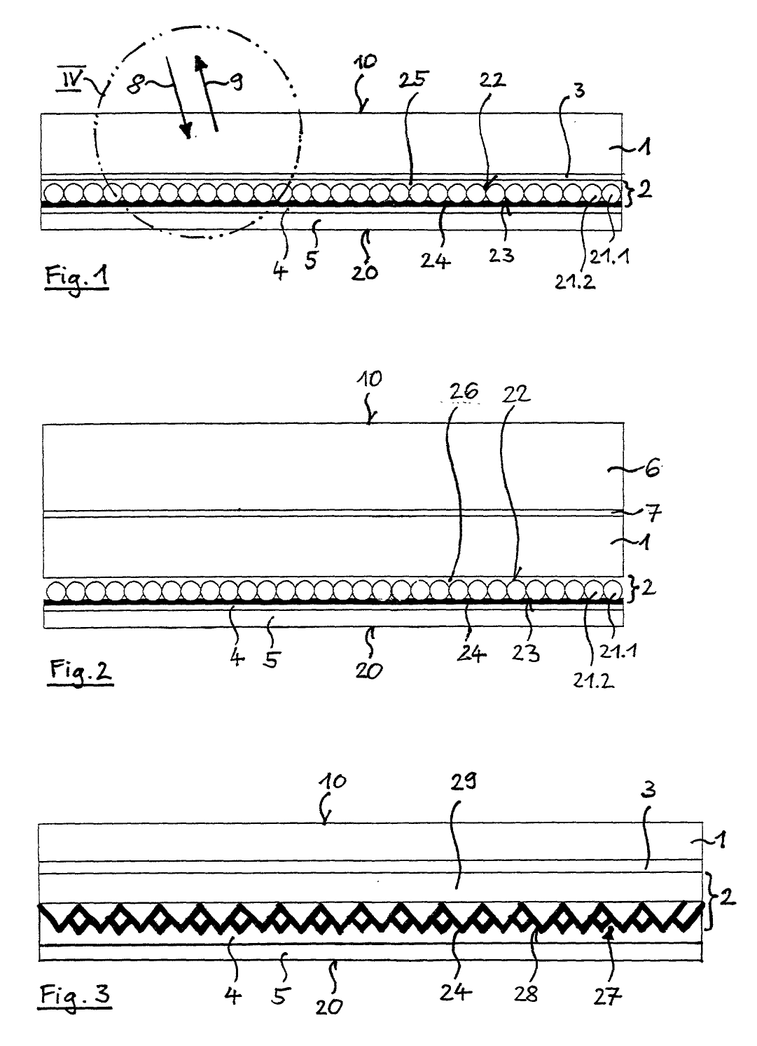

FIG. 2 shows an embodiment of the inventive structure with a second layer 2 in the form of a retroreflection film of subtype (3)(a). Here, glass balls 21.1, 21.2, etc. are not, or at least not completely, embedded in a support layer and instead their tops 22 are freely exposed in an air layer 26. Phase retardation film 1 is placed on the glass ball tops 22. For protection against external mechanical effects, it is advantageous to provide the structure with a fixed protective covering 6, e.g., with a glass or plexiglass plate. A third adhesive coating 7 or an air layer is located between phase retardation film 1 and protective covering 6.

FIG. 3 shows an embodiment of the inventive structure with a second layer 2 in the form of a retroreflection film of type 1). Here, the second layer comprises a micro-prism triple structure 27 (cf. FIGS. 5 to 7), the back surface 28 of which is metallized with a metal coating 24. Micro-prism triple structure 27 is applied to a support film 29. The individual triples have typical dimensions of approximately 0.1 to 0.5 mm. Otherwise this embodiment corresponds to that of FIG. 1.

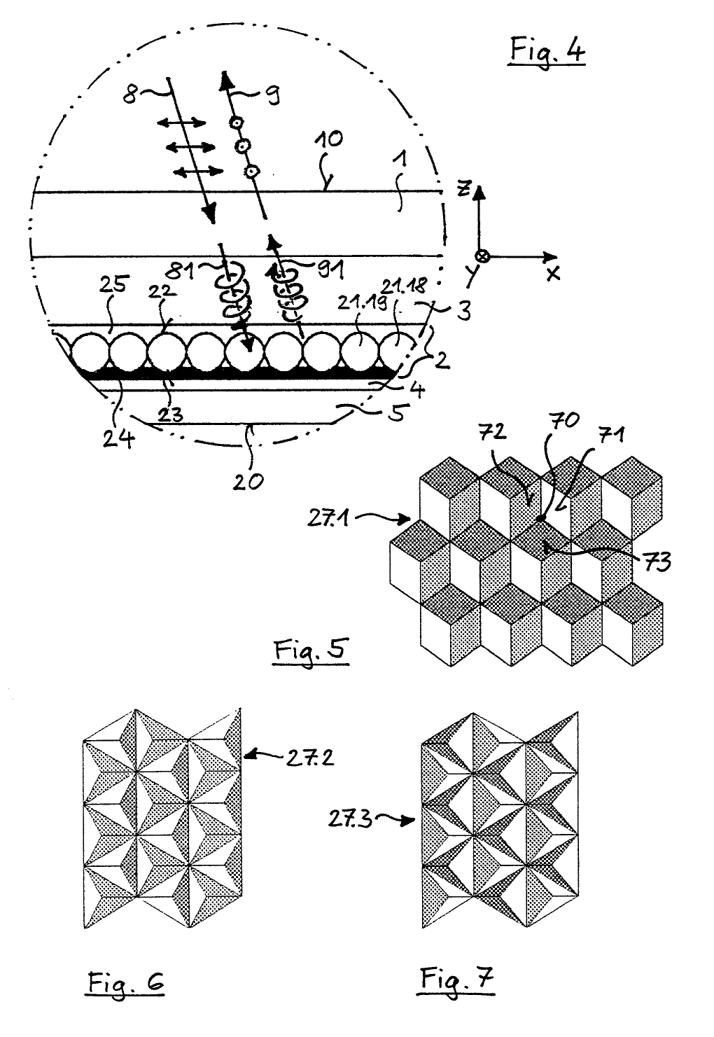

FIG. 4 diagrammatically shows the light retroreflection method according to the invention using the structure of FIG. 1 although, for simplicity of illustration, the thickness ratios of the individual layers do not necessarily coincide with those of FIG. 1. An incident light beam 8 is, e.g., linearly polarized in the x-direction. The principal axes of the λ/4 film 1 lie in the x-y plane and are perpendicular to each other and forms with the x-axis an angle of +45° (rapid axis) or −45° (slow axis). In order for their to be circularly polarized light, the polarization direction of the incident light must form an angle of 45° with one of the principal axes. Following a first traversal of λ/4 film 1, the light beam 81 is circularly polarized to the right. At least part of the light 81 is retroreflected on the second layer 2. During this metallic reflection, the polarization state of the light is converted from right circular to left circular. The retroreflected part 91 of the light traverses λ/4 film 1 a second time. The left circular polarized light 91 is converted into light 9, which is linearly polarized in the y-direction.

FIGS. 5 to 7 are plan views of different embodiments of triple structures 27.1, 27.2, 27.3, which are usable for the second layer 2 of the inventive structure. Such a triple structure 27.1, 27.2, 27.3 has a plurality of points 70 which can be referred to as “cube angles”, where three orthogonal reflecting surfaces 71, 72, 73, at an angle of in each case 90° to one another, meet. It has the characteristic of retroreflecting a large part of the incident light, not shown in FIGS. 5-7, in the incidence direction. The triple structures 27.1, 27.2, 27.3 can, e.g., be metallized on their backs, i.e. covered with a metal coating (cf. FIG. 3). FIG. 5 shows a structure 27.1 with complete triples, FIG. 6 a structure 27.2 with cut triples and FIG. 7 a structure 27.3 with cut, oblique triples.

Whereas only certain advantageous embodiments of the invention have been discussed, with the knowledge of the invention, the expert can derive further embodiments which also are within the scope of the invention.

What is claimed is:

1. A laminated structure for the retroreflection of light (8) in a polarized state comprising
a first layer (1) for receiving an incident light beam and for modifying the polarization characteristics of said incident light beam as it passes through said first layer, and
a second layer (2) for retroreflecting at least part of said incident light beam through said first layer.

2. A structure according to claim 1 wherein said first layer (1) comprises one of a phase retardation element, a circular polarizer, a liquid crystal layer or a depolarizer.

3. A structure according to claim 2 wherein said first layer (1) comprises a plastic retardation film for introducing a phase retardation of λ/4 or an odd-numbered multiple thereof into said incident light beam.

4. A structure according to claim 1 wherein said second layer (2) is constructed to reflect light metallically without a phase change.

5. A structure according to claim 1 wherein said second layer (2) contains spherical or triple retroreflecting structures (21.1, 21.2, 27).

6. A structure according to claim 5 wherein said retroreflecting structures (21.1, 21.2, . . . , 27) are at least partly metallized on one side (23, 28).

7. A structure according to claim 6 wherein said second layer (2) contains glass balls (21.1, 21.2, etc.) embedded in a support layer (25).

8. A structure according to claim 1 including an adhesive coating (3) between said first layer (1) and said second layer (2).

9. A structure according to claim 1 wherein said structure is flexible.

10. A method for the retroreflection of light comprising the steps of
forming a laminated structure comprising a first layer (1) and a second layer (2),
passing an incident beam of light through the first layer (1) a first time,
retroreflecting at least part (91) of the incident beam of light (8) in the second layer (2) back to the first layer,
passing the retroreflected part (9 1) of the beam of light through the first layer (1) a second time, and
modifying the polarization state of the beam of light during at least one of the first and second passages of the light through the first layer (1).
